(19) United States
(12) Patent Application Publication
(10) Pub. No.: US 2022/0308304 A1
(43) Pub. Date: Sep. 29, 2022

(54) IMAGING MODULE AND METHOD FOR FABRICATING SAME

(71) Applicant: NINGBO SEMICONDUCTOR INTERNATIONAL CORPORATION, Beilun District Ningbo, Zhejiang (CN)

(72) Inventors: Herb He HUANG, Beilun District Ningbo, Zhejiang (CN); Luo GUI, Beilun District Ningbo, Zhejiang (CN); Yanghui XIANG, Beilun District Ningbo, Zhejiang (CN)

(21) Appl. No.: 17/621,095

(22) PCT Filed: Jun. 24, 2020
(86) PCT No.: PCT/CN2020/097908

§ 371 Date: Dec. 20, 2021

(30) Foreign Application Priority Data
Dec. 16, 2019 (CN) 201911295080.7

(51) Int. Cl. G02B 7/02; H02N 1/00; G02B 26/08

(52) U.S. Cl. CPC G02B 7/023; H02N 1/006; G02B 26/0875

(57) ABSTRACT

In this invention, an imaging module and a method for fabricating it are provided. By designing first and second electrodes, a movable part of the second electrode is connected to the flexible part. Upon a voltage being applied to the first and second electrodes, the second electrode moves toward the first electrode, resulting in a stretch and hence a shape change of a flexible part. As a result, the imaging module undergoes a change in terms of focal length, amount of admitted light and/or admissible range of angle of incident light. In particular, a motion controller incorporating the first and second electrodes can be easily fabricated by semiconductor processes to a very small size, making the imaging module very suitable for use in electronic terminals such as mobile phones with confined enclosure spaces.

### TECHNICAL FIELD

The present invention relates to the field of optical imaging technology and, in particular, to an imaging module and a method for fabricating the imaging module.

### BACKGROUND

Zoom lenses are critical to optical imaging and many other applications. Focusing a traditional optical lens with invariable imaging parameters (e.g., focal length) requires adjusting the object and image distances by moving the lens so that an image of the object is formed on an image plane. Most existing focusing systems work in this way and suffer from the problems of a large volume/footprint, cumbersomeness, a sophisticated mechanical displacement device required to move the lens and high cost.

In order to overcome this, some have proposed the concept of a “flexible part”, a lens made of a flexible transparent material, which varies its own shape/optical surface shape when stressed by an external mechanical force, resulting in a change in a single imaging parameter (e.g., focal length). For a legacy macro-lens (e.g., with a diameter of several centimeters), when fabricated from a too flexible material, it tends to suffer from significant surface shape variation caused by its own heavy weight. On the other hand, when made from a too stiff material, it will be short in stretchability and tensility as desired for the use as a flexible part. One form of such a zoomable and focusable optical lens is a piezoelectric driven optical lens including a glass substrate, a flexible organic polymer layer located on the glass substrate, and an ultra-thin piezoelectric glass film located on the flexible organic polymer layer. When energized, the piezoelectric glass thin film will deform, causing a shape change and thus accomplishing a zooming action of the flexible organic polymer layer. However, such flexible parts are inconvenient to integrate with wafer-level semiconductor processes, and since the flexible organic polymer layer is sandwiched between the two layered substrates, it has to have a flat but not, for example, aspheric, concave or saddle-like surface, leading to a limited zooming range.

Another type of zoomable optical lens incorporates a liquid crystal lens, which has a curved surface that changes its shape as a function of a voltage applied thereto. However, such liquid crystal lenses suffer from low light transmittance and high power consumption. Apart from these, a liquid lens consisting of an elastic membrane and two media of different refractive indices on opposing sides of the membrane, e.g., two liquids, or a liquid and the air, may change its focal length by reshaping the elastic membrane through heating or pressurizing the medias or through injecting an additional liquid into the lens or discharging one of the liquids from the lens. However, there is no established robust liquid lens fabrication process and it is hard to be compatible with semiconductor processes.

It has been found that when the size of a flexible part is reduced to several millimeters, a good trade off can be achieved between the material flexibility and surface shape retention ability (in this case, even when the material is highly flexible and easily stretchable, the lens' gravity will only have a substantially negligible impact on the surface shape). On the other hand, millimeter-scale flexible parts can meet the requirements of camera modules of terminals such as mobile phones in terms of size, and their auto-zooming capabilities can to a great extent dispense with the use of voice coil motors/actuators (VCM/VCA). Such auto-zooming capabilities can impart self-focusing capacities to an imaging module, thus saving a space for accommodating the movement of a lens (group) in the module, which is in particular beneficial when the module is a miniature one. Therefore, the development of an imaging module with zooming capabilities has become a new area of interest in the art.

### SUMMARY OF THE INVENTION

It is an object of the present invention to provide an imaging module with a variable imaging parameter and a method for fabricating such an imaging module.

To this end, in an aspect of the present invention, there is provided an imaging module comprising:

a flexible part comprising a flexible optic or a flexible diaphragm; and

a motion controller comprising a mount and at least one electrode set provided on the mount, wherein the electrode set comprises a first electrode and a second electrode spaced apart from the first electrode, and wherein the second electrode comprises a fixed part and a movable part joined to the fixed part, the fixed part fixed on the mount, the movable part suspended over the mount, the movable part of the second electrode connected to the flexible part,

wherein upon a voltage being applied to the first and second electrodes, the second electrode moves toward the first electrode, resulting in a stretch and thus a shape change of the flexible part.

In another aspect of the present invention, there is provided a method for fabricating an imaging module, comprising:

forming a motion controller comprising a mount and at least one electrode set provided on the mount, wherein the electrode set comprises a first electrode and a second electrode spaced apart from the first electrode, and wherein the second electrode comprises a fixed part and a movable part joined to the fixed part, the fixed part fixed on the mount, the movable part suspended over the mount; and

connecting a flexible part to the movable part of the second electrode, the flexible part comprising a flexible optic or a flexible diaphragm,

wherein upon a voltage being applied to the first and second electrodes, the second electrode moves toward the first electrode, resulting in a stretch and thus a shape change of the flexible part.

In the provided imaging module and the method, the first and second electrodes are so designed that upon a voltage being applied thereto, the second electrode moves toward the first electrode, resulting in a stretch and hence a shape change of the flexible part. As a result, the focal length, amount of admitted light and/or admissible range of angle of incident light of the imaging module is/are modified. In particular, the motion controller incorporating the first and second electrodes can be easily fabricated by semiconductor processes to a very small size, making the imaging module very suitable for use in electronic terminals such as mobile phones with confined enclosure spaces.

### BRIEF DESCRIPTION OF THE DRAWINGS

FIG. 1 is a structural schematic of an imaging module according to Embodiment 1 of the present invention.

FIG. 2 is a structural schematic of first and second electrodes according to Embodiment 1 of the present invention.

FIG. 3 is a structural schematic of a mount according to Embodiment 1 of the present invention.

FIG. 4 is a structural schematic of one electrode set and one connecting member according to Embodiment 2 of the present invention.

FIG. 5 is a structural schematic of two electrode sets and one connecting member according to Embodiment 2 of the present invention.

FIG. 6 is a structural schematic of an imaging module according to Embodiment 3 of the present invention.

FIG. 7 is a structural schematic of a mount according to Embodiment 4 of the present invention.

FIG. 8 is a structural schematic of mount segments and electrode sets according to Embodiment 4 of the present invention.

FIG. 9 is a structural schematic of a motion controller according to Embodiment 5 of the present invention.

FIG. 10 is a structural schematic of a motion controller according to Embodiment 6 of the present invention.

FIG. 11 is a structural schematic of a motion controller according to Embodiment 7 of the present invention.

FIGS. 12 to 16 are partial schematic cross-sectional views of structures formed in a method for fabricating an imaging module according to Embodiment 8 of the present invention.

FIGS. 17 to 19 are partial schematic cross-sectional views of structures formed in a method for fabricating an imaging module according to Embodiment 9 of the present invention.

FIGS. 20 to 24 are partial schematic cross-sectional views of structures formed in a method for fabricating an imaging module according to Embodiment 10 of the present invention.

FIGS. 25 to 30 are partial schematic cross-sectional views of structures formed in a method for fabricating an imaging module according to Embodiment 11 of the present invention.

FIGS. 31 to 37 are partial schematic cross-sectional views of structures formed in a method for fabricating an imaging module according to Embodiment 12 of the present invention.

FIGS. 38 to 47 are partial schematic cross-sectional views of structures formed in a method for fabricating an imaging module according to Embodiment 13 of the present invention.

A description of reference numerals used in the figures is set forth below (throughout the figures, like elements are given the same or analogous reference numbers, for the sake of clarity in explaining the relationships between the elements).

10: a flexible part; 11: a motion controller; 20: a mount; 21: an electrode set; 22: a connecting member; 23: an axis of symmetry; 24: a side wall; 25a: a first receptacle; 25b: a second receptacle; 26: a cap; 30: a first electrode; 31: a second electrode; 32: a first voltage input terminal; 33: a second voltage input terminal; 34: a first via structure; 35: a second via structure; 40: a fixed part; 41: a movable part; 42: a first end; 43: a second end; 44: a fixation structure; 45: a third end; 46: a fourth end; 47: a connecting surface; 48: a fifth end; 49: a sixth end; 50, 50a, 50b, 50c, 50d: mount segments;

100: a substrate; 110: a patterned first sacrificial layer; 111: a first opening; 112: a second opening; 113: a third opening; 120: a barrier layer; 130: a patterned barrier layer; 131: a first anti-adhesive section; 132: a flat section; 133: an alignment section; 140: a first conductive layer; 150: a second conductive layer; 151: a second anti-adhesive section; 160: a patterned insulating layer; 161: a first slot; 162: a second slot; 170: a second sacrificial layer; 180: a patterned second sacrificial layer; 181: a fourth opening; 182: a fifth opening; 183: a sixth opening; 190: a cap layer; 191: a first cap layer; 192: a second cap layer; 193: a seventh opening; 194: an eighth opening; 195: a ninth opening; 200: a protective layer; 210: an eleventh opening; 211: a twelfth opening.

### DETAILED DESCRIPTION

Imaging modules and methods for fabricating the imaging modules provided in the present invention will be described below in greater detail with reference to particular embodiments and to the accompanying drawings. Features and advantages of the invention will be more apparent from the following description, and from the appended claims. Note that the figures are provided in a very simplified form not necessarily drawn to scale for the only purpose of helping to explain the disclosed exemplary embodiments in a more convenient and clearer way. In particular, as the drawings usually represent different emphasis of illustration, and depending on how this document is actually presented, there may be differences in scale among them.

### Embodiment 1

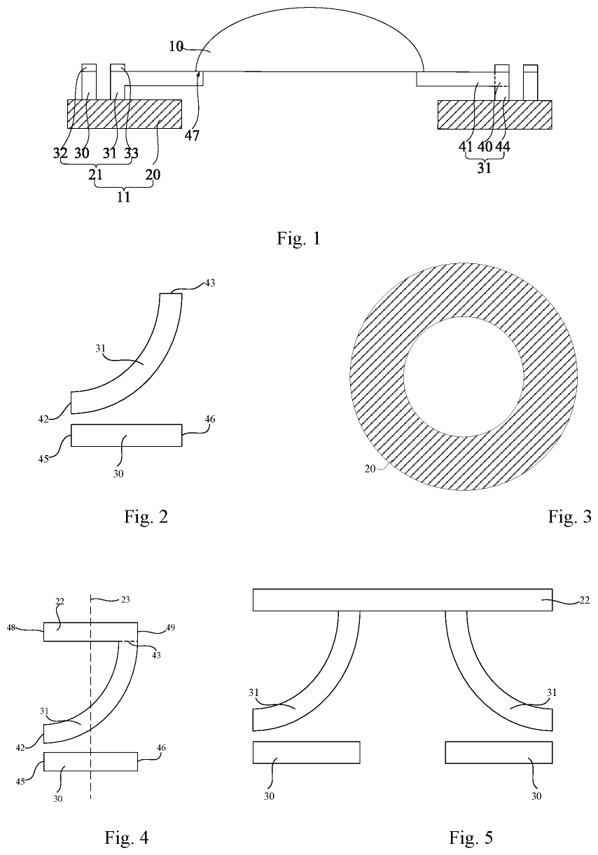

Reference is now made to FIG. 1, a structural schematic of an imaging module, FIG. 2, a structural schematic of first and second electrodes, and FIG. 3, a structural schematic of a mount, according to Embodiment 1 of the present invention. FIG. 1 is a schematic cross-sectional view of the imaging module. FIG. 2 is a schematic top view of the first and second electrodes. FIG. 3 is a schematic top view of the mount. Specifically, for clarity of illustration, the schematic top view of FIG. 2 is a more detailed view of the first and second electrodes that are also shown in FIG. 1, and these figures may not be drawn exactly to the same scale. Similarly, for clarity of illustration, the schematic top view of FIG. 3 is a more detailed view of the mount that is also shown in FIG. 1, and these figures may not be drawn exactly to the same scale.

As shown in FIGS. 1 to 3, the imaging module includes a flexible part 10 and a motion controller 11. The motion controller 11 includes a mount 20 and at least one electrode set 21 provided on the mount 20. The electrode set 21 includes a first electrode 30 and a second electrode 31 spaced apart from the first electrode 30. The second electrode 31 is connected to the flexible part 10. When a voltage is applied to the first 30 and second 31 electrodes, the second electrode 31 moves toward the first electrode 30, resulting in a stretch and thus a shape change of the flexible part 10.

The flexible part 10 includes a flexible optic and a flexible diaphragm. The flexible part 10 may be formed of a material selected from an organic polymer including polydimethylsiloxane (PDMS) or polyimide (PI). In particular, the material of the flexible part 10 may be a gel-like material with a Young's modulus less than 200 MPa. In addition, the gel-like material must satisfy the constraint that, for given dimensions and structure of the flexible part, an amount of deformation of the flexible part caused by its own gravity is less than 1/10 of a minimum dimension in the same direction. For example, when the flexible part is designed with a flat bottom surface, for a maximum amount of gravity-caused sag (collapse) of x, then the flexible part will be considered as meeting the design requirements if its minimum initial thickness measured in the vertical direction is greater than 10×. Otherwise, it is necessary to increase its stiffness through modifying the design (e.g., by reducing the size or increasing the thickness) or choosing a stiffer material. Further, for the given dimensions and structure, the motion controller must be able to provide a driving force allowing the desired deformation. Therefore, a material with a lower Young's modulus is suitable for fabricating a flexible part with a smaller size or a greater thickness, and a material with a higher Young's modulus is suitable for fabricating a flexible part with a greater size or smaller thickness.

In embodiments hereof, the flexible part 10 includes the flexible optic which may be implemented as either a flexible optic or a flexible mirror. The flexible part 10 may be stretched and thus undergo a shape change, which in turn results in a focal length change of the flexible part 10 Specifically, the flexible optic may have optical surface(s) each of any of suitable shapes that can be machined by various processes. The flexible optic may have a spherical or aspheric surface. Alternatively, the flexible optic may have a flat surface and an opposing concave, convex or otherwise shaped surface. In embodiments hereof, when the flexible optic is stretched, a change may occur in the curvature of the concave or convex surface, leading to a focal length change of the optic. As an example, the flexible optic, for example, of a plano-convex structure may be stretched so as to experience a change in the convexity of the convex surface, or even to turn to a plano-plano or plano-concave structure. The voltage applied to the first 30 and second 31 electrodes may create an electrostatic attraction that may cause at least part of the second electrode 31 to move toward the first electrode 30. Since the flexible part 10 is connected to the second electrode 31, the movement of the second electrode 31 toward the first electrode 30 will pull and stretch the flexible part 10. As a result, the flexible part 10 may change the shape and have a different focal length.

The electrode set 21 may further include a first voltage input terminal 32 electrically connected to the first electrode 30 and a second voltage input terminal 33 electrically connected to the second electrode 31. In embodiments hereof, the first voltage input terminal 32 is arranged on the first electrode 30 at any suitable location thereof, and the second voltage input terminal 33 is arranged on the second electrode 31, in particular on a fixed part thereof.

Both the first 32 and second 33 voltage input terminals may be formed of a metal such as aluminum. In order to protect the first 32 and second 33 voltage input terminals against corrosion and the like, the first 32 and second 33 voltage input terminals may be each optionally coated with an electroplated protective layer such as an electroless nickel-immersion gold coating.

In embodiments hereof, the mount 20 is formed of a non-conductive material such as monocrystalline silicon and/or glass commonly used in semiconductor technology. Accordingly, the mount 20 may include a monocrystalline silicon layer and a barrier layer formed on the monocrystalline silicon layer. The barrier layer may be, for example, formed of silicon nitride that can ensure good electrical insulation between the first 30 and second 31 electrodes.

In embodiments hereof, the first 30 and second 31 electrodes may be each formed of a conductive material. Optionally, the material may be doped polysilicon or a metal such as aluminum or copper, which is commonly used in semiconductor processes.

In this embodiment, the first 30 and second 31 electrodes have equal thicknesses. In alternative embodiments, the first 30 and second 31 electrodes may have distinct thicknesses.

The first 30 and second 31 electrodes are configured to connect an external voltage within an upper voltage limit that is related to an upper voltage limit for the device in which the imaging module is to be used. The electrostatic force between the first 30 and second 31 electrodes is related to the voltage applied to the first 30 and second 31 electrodes. However, the second electrode 31 may have a degree of resilience that is related to the material and thickness of the second electrode 31. The difference between the electrostatic force between the first 30 and second 31 electrodes and the resilience force of the second electrode 31 is related to a tensile force applied to the flexible part. Therefore, the design of this embodiment takes into account the Young's modulus of the flexible part, the material and thickness of the second electrode 31, the distance and ratio of areas of the first 30 and second 31 electrodes, and the voltage applied to the first 30 and second 31 electrodes, in order to ensure that the flexible part can deform in a desired away.

Each of the first 30 and second 31 electrodes may be surface coated with an insulating layer, in order to prevent an electrical connection established between the first 30 and second 31 electrodes. The flexible part 10 may be bonded and attached to the second electrode 31, in particular by an adhesive applied onto the second electrode 31.

With continued reference to FIGS. 1 and 2, in embodiments hereof, the second electrode 31 includes a fixed part 40 and a movable part 41 joined to the fixed part 40. The fixed part 40 is fixed on the mount 20, and the movable part 41 is suspended over the mount 20. Upon the voltage being applied to the first 30 and second 31 electrodes, the movable part 41 will move toward the first electrode 30. The fixed 40 and movable 41 parts may be integrated with each other so that the fixed part 40 is located on either end of the movable part 41 or sandwiched between two different portions of the movable part 41.

Optionally, the second electrode 31 may have a first end 42 and a second end 43 opposing the first end 42. The first end 42 may be closer to the first electrode 30 than the second end 43. The fixed part 40 may be provided by the first end 42. The fixed part 40 may be provided either entirely or partially by the first end 42. In the latter case, the fixed part 40 may have another portion extending from the first end 42 toward the second end 43. That is, the first end 42 may be considered as a part of the fixed part 40. Still alternatively, the first end 42 may be partially provided by the fixed part 40. In this case, the fixed part 40 may be considered as a part of the first end 42. However, the present invention is not limited in this regard. The second end 43 may be a part of the movable part 41, and the movable part 41 may further include, in addition to the second end 43, a portion of the second electrode 31 between the second end 43 and the fixed part 40.

The first electrode 30 may have a rectangular parallelepiped shape, while the second electrode 31 may further include a fixation structure 44 having a shape of cylinder. The second electrode 31 may be elongate in shape and fixed to the mount 20 at the fixed part 40 via the fixation structure 44. As shown in FIG. 2, the first electrode 30 may have a third end 45 and a fourth end 46 opposing the third end 45. The first end 42 may be aligned with, or extend beyond, the third end 45. The second end 43 may be aligned with, or extend beyond, the fourth end 46. This maximizes an aligned area between the first 30 and second 31 electrodes and hence maximizes a range in which the electrostatic attraction between the second 31 and first 30 electrodes (created upon the voltage being applied) can vary, thus facilitating the control of an amount of stretch of the flexible part 10.

The magnitude of the electrostatic force between the first 30 and second 31 electrodes may depend on the positional relationship between the second 31 and first 30 electrodes. In this embodiment, the second 31 and first 30 electrodes (or extensions thereof) are provided with an angle equal to or less than 10 degrees. Accordingly, the movable part 41 and the first electrode 30 (or extensions thereof) are provided with an angle equal to or less than 10 degrees.

The angle between the second 31 and first 30 electrodes that is less than or equal to 10 degrees ensures a large aligned area between the second 31 and first 30 electrodes, which allows an electrostatic force therebetween that is large enough to overcome the resilience of the second electrode 31 and exert a tensile force on the flexible part.

In this embodiment, the first electrode 30 has a length not less than 10 μm, a thickness not less than 1 μm and a width (when viewed from the top) not limited to any particular value.

In this embodiment, the second electrode 31 has a length not less than 10 μm and not more than 500 μm, a thickness not less than 1 μm and a minimum width (when viewed from the top) not more than 5 μm.

If the length of the second electrode 31 is less than 10 μm, the aligned area between the first 30 and the second 31 electrodes will be too small to allow the generation of a sufficient tensile force. On the other hand, for considerations of stability and motion control accuracy after the voltage is removed, it is not suitable for the second electrode 31 to have a very large length. When the length of the second electrode 31 is greater than 500 μm, inevitable vibration of the electrode will be expected, and the electrode will be not stable due to a too large size.

The movable part 41 of the second electrode 31 may be spaced from the mount 20 by a distance ranging from 0.1 μm to 5 μm.

With combined reference to FIGS. 1 and 3, each electrode set 21, more exactly, the second electrode 31 thereof may have a connecting surface 47 that connects the flexible part 10. The connecting surface 47 may be a bottom surface (facing the mount 10) or a top surface (facing away from the bottom surface) of a part of the movable part 41. Optionally, the connecting surface 47 of every electrode set 21 may be located in the same flat surface and may be connected to the same surface of the flexible part 10. This imparts higher stability to the flexible part 10 and facilitates stretch control of the flexible part 10. In alternative embodiments hereof, the connecting surface 47 of every electrode set 21 may be alternatively located in an individual respective flat surface or connect to an individual respective surface of the flexible part 10.

The second electrode 31 may be connected to a peripheral rim of the flexible part 10, which may have a circular cross section along the connecting surface 47. In embodiments hereof, the surface of the flexible part 10 to which the second electrode 31 is connected may be circular in shape when in a rest condition thereof (without a voltage being applied to the first 30 and second 31 electrodes). Optionally, the mount 20 may be a circular annulus. In embodiments hereof, the mount 20 may be an integral one-piece structure. An outer diameter of the mount 20 may be greater than a diameter of the flexible part 10, and an inner diameter of the mount 20 may be equal to, or slight greater/smaller than, the diameter of the flexible part 10. The outer and inner diameters of the mount 20 may be designed primarily based on the diameter and a designed amount of stretch of the flexible part 10. In other embodiments hereof, the mount 20 may alternatively have the shape of a rectangular annulus, a polygonal annulus or the like. Specifically, the mount 20 may be arbitrarily shaped, as practically needed, based on the shape of the flexible part 10. For example, depending on the shape of the flexible part 10, the hollow interior of the mount 20 may assume a rectangular, circular or other shape. As practically required, or depending on where the mount 20 is deployed, the mount 20 may have a rectangular, circular, polygonal, irregularly or otherwise shaped outer edge. However, the present application is not so limited.

Optionally, a plurality of electrode sets 21 may be arranged on the mount 20. Eight or more electrode sets 21 may be provided. For example, eight, twelve or another number of electrode sets 21 may be provided. In such cases, all the electrode sets 21 may be uniformly distributed circumferentially across the peripheral rim of the flexible part 10. Optionally, all the electrode sets 21 may have the same shape, i.e., include identically shaped and sized first electrodes 30, identically shaped and sized second electrodes 31, and identical positional relations between the respective first 30 and respective second 31 electrodes. This makes stretch control of the flexible part 10 easier and more reliable. A greater number of electrode sets 21 that are uniformly distributed circumferentially across the peripheral rim of the flexible part 10 allow a more uniform tensile force distribution on the flexible part 10 and high circularity of the peripheral rim in a stretched condition of the flexible part 10. As a result, better optical performance can be achieved.

In case of a plurality of electrode sets being provided, the distance between any adjacent two of them may be 1 μm or more. If the distance between any adjacent two of them is less than 1 μm, then it is difficult to achieve in fabrication.

In this embodiment, the imaging module further includes a barrel. Additionally, the mount is fixed to a side wall of the barrel, and the flexible part is housed in the barrel.

The side wall of the barrel may be a continuous wall, and the mount may be fixed to the side wall so that the connecting surface between the flexible part and the motion controller is perpendicular to a side wall of the mount.

The barrel is provided to protect the lens module against the ingress of dirt or dust and to provide the mount with support.

In this embodiment, the imaging module further includes an image sensor surrounded by the barrel.

In one embodiment, the image sensor is formed on a substrate, and the barrel is arranged on the substrate so as to surround the image sensor. The substrate comprises external power supply input terminals. The first 32 and second 33 voltage input terminals may be connected to external power supply input terminals on the substrate by flexible wires so that the motion controller can be powered by the external power supply. The substrate may include a PCB or similar arrangement for carrying the imaging module and provided therewith electrical signals.

In the imaging module of the present invention, by designing the first and second electrodes, a voltage applied to the first and second electrodes can cause the second electrode to approach the first electrode, thus resulting in a stretch and a shape change of the flexible part. As a result, the focal length of the imaging module is modified.

Further, both the flexible part and the image sensor are arranged in the barrel, with the mount being fixed to the side wall of the barrel. Since the position of the mount determines the position of the flexible part, the flexible part is positioned at a fixed distance from the image sensor. Thus, changing the focal length of the flexible part can enlarge or reduce an image formed on the image sensor, imparting thereto telephoto or wide-angle imaging capabilities. The variable focal length makes the lens module versatile.

### Embodiment 2

Embodiment 2 differs from Embodiment 1 primarily in that the motion controller further includes at least one connecting member. One connecting member connects at least one second electrode, and the flexible part connects the second electrode through the connecting member.

Particular reference is now made to FIG. 4, a diagram (top view) schematically illustrating the structures of one electrode set and one connecting member according to Embodiment 2 of the present invention. Referring to FIG. 4, in combination with FIGS. 1 to 3, the motion controller 11 further includes at least one connecting member 22. As illustrated, one connecting member 22 is connected to, and optionally integrated or integrally formed, with one second electrode 31. The flexible part 10 may be adhesively bonded to the connecting member 22 and thus connected to the second electrode 31.

With continued reference to FIG. 4, in embodiments hereof, the connecting member 22 may be exactly aligned with the first electrode 30 (of the same electrode set 21 to which the second electrode 31 connected to the specific connecting member 22 belongs). A surface of connecting member 22 facing the first electrode 30 may be parallel to a surface of the first electrode 30 facing the connecting member 22, and the second electrode 31 may be obliquely arranged between the connecting member 22 and the first electrode 30 so that the second 31 and first 30 electrodes are provided with an angle equal to or less than 10 degrees. Specifically, the second electrode 31 may be so inclined between the connecting member 22 and the first electrode 30 that a fifth end 48 is closer to the third end 45 than a sixth end 49 and the sixth end 49 is closer to the fourth end 46 than the fifth end 48, and that the first end 42 is closer to the third end 45 than to the fourth end 46 and the second end 43 is closer to the sixth end 49 than to the fifth end 48.

Optionally, the connecting member 22 and the first electrode 30 may form a symmetrical structure with an axis of symmetry 23. The first 42 and second 43 ends may be positioned on opposing sides of the axis of symmetry 23.

In embodiments hereof, a surface width of the connecting member 22 may be greater than a surface width of the second electrode 31 in order to be easily connected to the flexible part 10. Alternatively, the surface width of the connecting member 22 may be smaller than the surface width of the second electrode 31, which allows more accurate stretch direction control of the flexible part 10.

Reference may be made to the description of Embodiment 1 for more details in the structure of the imaging module, such as how the fixed 40 and movable 41 parts of the second electrode 31 in the motion controller 11 are designed and how the motion controller 11 and the flexible part 10 are connected, and any repeated description will be omitted for the sake of brevity.

In alternative embodiments hereof, one connecting member may be connected to multiple second electrodes, for example, an even number of second electrodes are connected to one connecting member, and the second electrodes connected to the same connecting member are arranged in symmetry with respect to an axis of the connecting member.

Particular reference is now made to FIG. 5, a diagram (top view) schematically illustrating the structures of two electrode sets and one connecting member according to Embodiment 2 of the present invention. Referring to FIG. 5, in combination with FIGS. 1 to 4, one connecting member 22 may be connected to two second electrodes 31 that are arranged in symmetry with respect to an axis of the connecting member 22. Accordingly, the two first electrodes 30 that belong to the respective same electrode sets 21 as the respective second electrodes 31 may also be positioned in symmetry with respect to the axis of the connecting member 22.

In this way, it can be ensured that a component 10 to be moved is only movable radially without circumferential displacement, making the imaging module able to meet various applications.

In alternative embodiments hereof, one connecting member may be connected to an odd number of second electrodes, for example, three second electrodes. In this case, two of the second electrodes may be arranged in symmetry with respect to an axis of the connecting member, and the third second electrode may be positioned between or beside them. Alternatively, the three second electrodes may be so connected to the connecting member as to be arranged side by side.

In case of each connecting member 22 being connected to one or more second electrodes 31, the electrode(s) may exert (on the component 10 to be moved) tensile force(s) that is/are all equal in magnitude. Alternatively, all or some of the tensile force(s) may be unequal in magnitude. Additionally, all or some of the tensile force(s) may be exerted by the second electrode(s) 31 (on the component 10 to be moved) in distinct direction(s). In case of one connecting member 22 being connected to one second electrode 31, in addition to a horizontal translation in the direction of a tensile force by the electrode, the component 10 to be moved may also rotate at a certain angle. In case of one connecting member 22 being connected to two or more second electrodes 31, these second electrodes may exert different tensile forces so that the connecting member 22 component 10 to be moved not only translates horizontally but also rotates at a certain angle. In this way, the component 10 to be moved can be compensated for to a certain extent, thus imparting anti-shake ability to the component 10 to be moved which is, for example, an image sensor.

Reference may be made to the descriptions of the preceding embodiments for any other details of the imaging module that have not been described in the description of this embodiment, and any repeated description will be omitted for the sake of brevity.

### Embodiment 3

Embodiment 3 differs from the preceding embodiments primarily in that the flexible part further includes a flexible diaphragm. A diaphragm is capable of light admission and depth of field (DOF) control and considered as an important component for an imaging module. Legacy mechanical variable diaphragms are unsuitable for applications requiring integrated miniature cameras such as those for mobile phones. In the flexible part of Embodiment 3 incorporating the flexible diaphragm, upon a voltage being applied to the first and second electrodes, the second electrode moves towards the first electrode, resulting in a stretch and hence a shape change of the flexible part, which in turn changes the amount of light admitted by the flexible part and/or an admissible range of angle of incident light. The motion controller including the first and second electrodes can be easily fabricated by semiconductor processes to a very small size, making the imaging module very suitable for use in electronic terminals such as mobile phones with confined enclosure spaces.

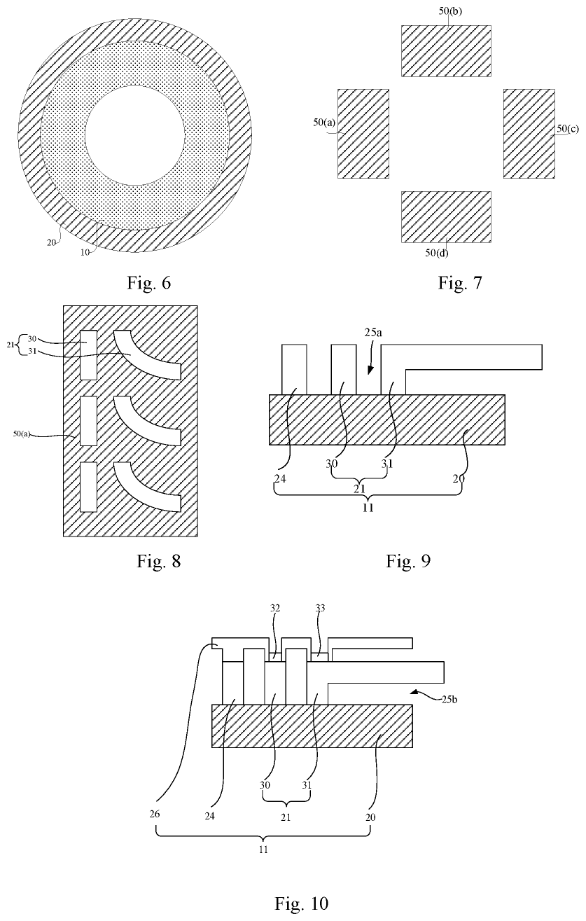

Particular reference is now made to FIG. 6, a structural schematic of the imaging module according to Embodiment 3 of the present invention, which is depicted as a top view. Referring to FIG. 6, in combination with FIGS. 1 to 5, in embodiments hereof, the flexible part 10 includes a flexible diaphragm, which is optionally a circular annular structure with uniform light input and hence optimal image quality. Additionally, the flexible diaphragm may be a uniform structure with a uniform thickness and width at various portions thereof. The flexible diaphragm may be both a one-axis symmetrical structure and a mono-centrosymmetric structure. When stretched, the flexible diaphragm will experience a change in its inner diameter and/or a change in its outer diameter, which will in turn change the amount of light admitted and/or admissible range of angle of incident light. In embodiments hereof, the mount 20 may also be a circular annular structure, and the flexible diaphragm may be made of a non-transparent (opaque) material selected, for example, from organic polymers.

### Embodiment 4

Embodiment 4 differs from the preceding embodiments primarily in that the mount includes a plurality of mount segments, which are spaced part from one another and uniformly arranged into a ring.

Particular reference is now made to FIG. 7, a structural schematic (top view) of the mount according to Embodiment 4 of the present invention. Referring to FIG. 7, in combination with FIGS. 1 to 6, the mount 20 may include four spaced mount segments 50, indicated at 50a, 50b, 50c and 50d, respectively, which are arranged into a ring. In particular, the mount segments 50 may be all rectangular (more exactly, rectangular parallelepiped bars) and arranged into a rectangular ring on which the flexible part 10 is supported.

Reference is additionally made to FIG. 8, a structural schematic (top view) of the mount segments and electrode sets according to Embodiment 4 of the present invention, which illustrates how the electrode sets 21 are distributed on the mount segments 50a merely by way of example. Electrode sets 21 may be distributed on the mount segments 50b, 50c, 50d in the same manner as those on the mount segment 50a. Here, by “in the same manner”, it is intended to mean that an equal number of electrode sets 21 are distributed on each of the mount segments 50b, 50c, 50d with the same mutual relationships (e.g., the same spacing arrangement, etc.). Alternatively, the electrode sets 21 on the mount segments 50b, 50c, 50d may also be distributed differently from those on the mount segment 50a. In the latter case, it is both possible that the electrode sets 21 on each of the four mount segments 50a, 50b, 50c, 50d are distributed in a distinct manner and that the electrode sets 21 on each of some of the four mount segments 50a, 50b, 50c, 50d are distributed in a first manner, with those on each of the rest electrode set(s) 21 being distributed in a different manner. However, the present application is not limited thereto.

Specifically, referring to FIG. 8, in combination with FIGS. 1 to 7, the motion controller 11 includes a plurality of electrode sets 21 that are divided into a number of groups, each of the groups comprises at least one electrode set 21, and the electrode sets 21 are distributed uniformly with respect to the flexible part. In embodiments hereof, the electrode sets 21 may be divided into four groups, each of the group has three electrode sets 21, and which are distributed uniformly with respect to the peripheral rim of the flexible part 10. The electrode sets 21 of the same group may be disposed on a same mount segments 50. In other words, the individual groups may be arranged on the respective mount segments 50. Stated more concretely, three electrode sets 21 of the same group are arranged on the mount segments 50a, and this also applies to each of the mount segments 50b, 50c, 50d.

When a voltage is applied to the first electrode 30 and the second electrode 31, all the second electrodes 31 in any of the groups may move in the same direction, while those in different groups may move in different directions. As an example, all the three electrode sets 21 on the mount segment 50a may move horizontally to the left, and all those on the mount segment 50b may move vertically upward. Additionally, all the three electrode sets 21 on the mount segment 50c may move horizontally to the right, and all those on the mount segment 50b may move vertically downward.

As a result, all the second electrodes 31 in any of the groups pull the flexible part 10 in the same direction, while those in different groups pull it in different directions. In addition, tensile forces exerted by the second electrodes 31 in any of the groups may be all equal in magnitude, while tensile forces exerted by those in different groups may be either equal in magnitude or not. For example, when a voltage is applied to all the electrode sets 21 on the mount segments 50a, 50b, 50c, 50d, the three second electrodes 31 in the respective electrode sets 21 on the mount segment 50a may exert horizontal tensile forces of a magnitude to the left, those in the electrode sets 21 on the mount segment 50b may exert vertical tensile forces of the same equal magnitude upward, those in the electrode sets 21 on the mount segment 50c may exert horizontal tensile forces of the same equal magnitude to the right, and those in the electrode sets 21 on the mount segment 50d may exert vertical tensile forces of the same equal magnitude downward, on the flexible part 10. As a result, the flexible part 10 is uniformly stretched in the four directions and thus changes its shape in a uniform way.

Likewise, reference may be made to the descriptions of the preceding embodiments for any other details of the imaging module that have not been described in the description of this embodiment, and any repeated description will be omitted for the sake of brevity.

### Embodiment 5

Embodiment 5 differs from the preceding embodiments primarily in that the motion controller further includes a side wall, which is disposed on the mount and forms therewith a first receptacle in which the electrode set is accommodated.

Particular reference is now made to FIG. 9, a structural schematic (cross-sectional view) of the motion controller according to Embodiment 5 of the present invention. Referring to FIG. 9, in combination with FIGS. 1 to 8, the motion controller 11 may further include a side wall 24, which is disposed on the mount 20 and forms therewith a first receptacle 25a in which the electrode set 21 is accommodated.

Further, (in each electrode set 21), the first electrode 30 may be located closer to the side wall 24 than the second electrode 31, with a part of the second electrode 31 protruding (projecting) beyond the mount 20. The side wall 24 is provided to protect the electrode set 21. Optionally, a length of the second electrode 31 that protrudes beyond the mount 20 may account for 2%-50% of a total length of the second electrode 31.

The side wall 24 may be formed in the same process as the first 30 and second 31 electrodes. Accordingly, the side wall 24 may be as tall as, and formed of the same material as, the first 30 and second 31 electrodes. In embodiments hereof, the material of the side wall 24 may be the same as that of the electrode set 21. In other words, the side wall 24 may be formed of doped polysilicon or a metal. Additionally, the side wall 24 may be surface-coated with an insulating layer. In embodiments hereof, the side wall 24 may be as tall as the first 30 and second 31 electrodes. In alternative embodiments hereof, the tallness and material of the side wall 24 may be different from those of the first 30 and second 31 electrodes. For example, the side wall 24 may be taller or shorter than the first 30 and second 31 electrodes. Further, the side wall 24 and the electrode set 21 may be formed on the mount 20 either simultaneously or at different times (successively).

Likewise, reference may be made to the descriptions of the preceding embodiments for any other details of the imaging module that have not been described in the description of this embodiment, and any repeated description will be omitted for the sake of brevity.

### Embodiment 6

Embodiment 6 differs from the preceding embodiments primarily in that the motion controller further includes a cap provided on the side wall, which forms, together with the side wall and the mount, a second receptacle where the electrode set is housed.

Particular reference is now made to FIG. 10, a structural schematic (cross-sectional view) of the motion controller according to Embodiment 6 of the present invention. Referring to FIG. 10, in combination with FIGS. 1 to 9, the motion controller 11 may further include a cap 26 provided on the side wall 24, which forms, together with the side wall 24 and the mount 20, a second receptacle 25b where the electrode set 21 is housed. Additionally, in each electrode set 21, the first electrode 30 may be closer to the side wall 24 than the second electrode 31. A part of the second electrode 31 may protrude (project) beyond the mount 20 and the cap 26. The cap 26 is included to provide the electrode set 21 with additional protection.

Optionally, a cross-sectional width of the cap 26 may be equal to a cross-sectional width of the mount 20. In other words, a length of the second electrode 31 that protrude (project) beyond the mount 20 is the same as a length of the second electrode 31 that protrude (project) beyond the cap 26. The cap 26 may be made of a non-conductive material such as undoped polysilicon. Optionally, the material of the cap 26 may be silicon nitride. In order to achieve increased reliability, the cap 26 may include a laminate structure consisting of undoped polysilicon and nitride layers.

In embodiments hereof, the first voltage input terminal 32 may be arranged on the first electrode 30 and the second voltage input terminal 33 on the second electrode 31. Openings may be formed in the caps 26, in which the first 32 and second 33 voltage input terminals are respectively exposed. In embodiments with one first voltage input terminal 32 and on second voltage input terminal 33, two independent openings may be formed, in which the respective voltage input terminals are exposed.

Reference may be made to the descriptions of the preceding embodiments for any other details of the imaging module that have not been described in the description of this embodiment, and any repeated description will be omitted for the sake of brevity.

### Embodiment 7

Embodiment 7 differs from the preceding embodiments primarily in that the first and second voltage input terminals are both arranged on a surface of the mount facing away from the electrode set.

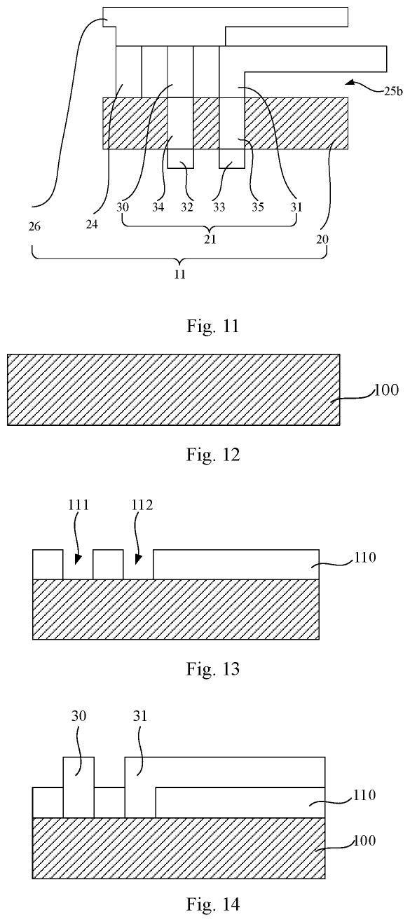

Particular reference is now made to FIG. 11, a structural schematic (cross-sectional view) of the motion controller according to Embodiment 7 of the present invention. Referring to FIG. 11, in combination with FIGS. 1 to 10, the first 32 and second 33 voltage input terminals may be both arranged on a surface of the mount 20 facing away from the electrode set 21 (also referred to hereinafter as the “backside”). The first voltage input terminal 32 may be electrically connected to the first electrode 30 by a first via structure 34, and the second voltage input terminal 33 may be electrically connected to the second electrode 31 by a second via structure 35. The first via structure 34 may extend through the mount 20 and come into electrical connection with the first electrode 30, and the second via structure 35 may extend through the mount 20 and come into electrical connection with the second electrode 31. The first voltage input terminal 32 may be electrically connected to the first via structure 34 and the second voltage input terminal 33 to the second via structure 35. Each of the first voltage input terminal 32, the second voltage input terminal 33, the first via structure 34 and the second via structure 35 may be fabricated from a conductive material such as a metal, doped polysilicon or the like.

Reference may be made to the descriptions of the preceding embodiments for any other details of the imaging module that have not been described in the description of this embodiment, and any repeated description will be omitted for the sake of brevity.

While some embodiment examples of this application have been described above, it is to be noted that more such embodiment examples can be made on the basis of the disclosure contained herein. As described herein, any preceding embodiment does not necessarily serve as a basis or premise for one or more succeeding embodiments, and the individual features described above may be combined arbitrarily to create various imaging modules other than those described above, without departing from the scope of the present application.

### Embodiment 8

In Embodiment 8, there is provided a method for fabricating an imaging module, which includes the steps of:

forming a motion controller including a mount and at least one electrode set disposed on the mount, each electrode set including a first electrode and a second electrode spaced apart from the first electrode; and

connecting a flexible part to the second electrode, the flexible part including an image sensor, a lens and/or a lens group.

Upon a voltage being applied to the first and second electrodes, the second electrode approaches the first electrode, resulting in a stretch and hence a shape change of the flexible part.

The step of connecting the flexible part to the second electrode may either follow or occur simultaneously with the step of forming the motion controller. For example, in one embodiment hereof, the connection of the flexible part to the second electrode may occur subsequent to both the formation of the second electrode and the suspension of a movable part of the second electrode over the mount. In an alternative embodiment hereof, the connection of the flexible part to the second electrode may occur subsequent to the formation of the second electrode and prior to the suspension of the movable part of the second electrode over the mount. However, the present application is not limited in this regard.

Particular reference is now made to FIGS. 12 to 16, which are partial schematic cross-sectional views of structures formed in the method according to Embodiment 8 of the present invention. Reference may be made further to FIGS. 1 to 11. Since the method of this embodiment corresponds principally to the imaging module of Embodiment 1, in addition to FIGS. 12 to 16, additional reference may be made in particular to FIGS. 1 to 3.

In embodiments hereof, first of all, as shown in FIG. 12, a substrate 100 is provided. The substrate 100 may be made of monocrystalline silicon or another non-conductive material such as glass.

Next, as shown in FIG. 13, a patterned first sacrificial layer 110 is formed on the substrate 100. In the patterned first sacrificial layer 110, there are a first opening 111 and a second opening 112, both extending through the layer in a thickness-wise direction thereof. Specifically, the formation of the patterned first sacrificial layer 110 may involve forming the first sacrificial layer on the substrate 100. The first sacrificial layer may be formed of, for example, silicon oxide or germanium (Ge) by physical vapor deposition, chemical vapor deposition or a similar semiconductor process. The first sacrificial layer 110 is then etched, for example, by a dry or wet etching process, and thus patterned so that the underlying substrate 100 is partially exposed. The etching and patterning of the first sacrificial layer 110 may be preceded by planarization of the first sacrificial layer 110. Optionally, the patterned first sacrificial layer 110 may have a thickness between 0.1 μm and 5 μm.

Subsequently, as shown in FIG. 14, the first electrode 30 filling a first opening 111 and the second electrode 31 filling a second opening 112 and extending over part of the patterned first sacrificial layer 110 are formed. The formation of the first 30 and second 31 electrodes may involve: forming a conductive layer, which fills the first 111 and second 112 openings and extends across a surface of the patterned first sacrificial layer 110; and etching the conductive layer so that the surface of the patterned first sacrificial layer 110 is partially exposed, resulting in the formation of the first 30 and second 31 electrodes.

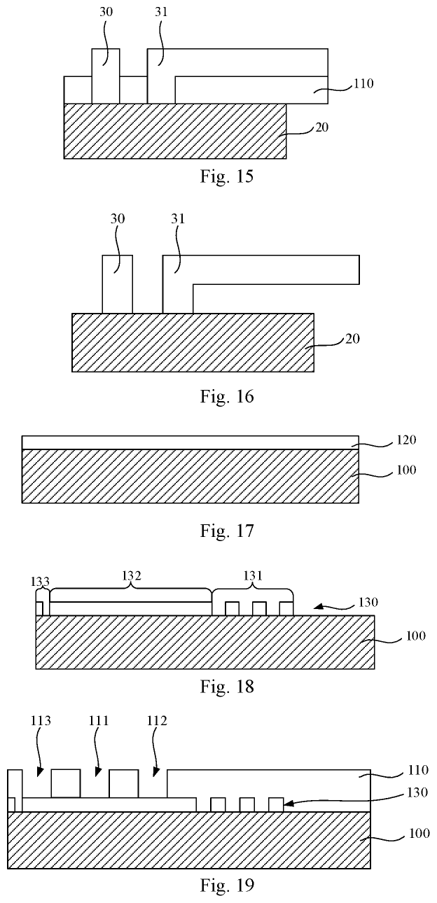

Afterward, as shown in FIG. 15, the substrate 100 is etched from a backside so that part of the patterned first sacrificial layer 110 that is aligned with part of the second electrode 31 is exposed. In this way, the mount 20 is formed as the remainder of the substrate 100.

As shown in FIG. 16, the patterned first sacrificial layer 110 is removed. As a result, the second electrode 31 is partially suspended, and the part of the second electrode 31 that is aligned with said part of the patterned first sacrificial layer 110 exposed in the previous step protrudes (projects) beyond the mount 20.

In this way, the motion controller 11 is formed, and the flexible part 10 is then bonded and connected to the second electrode 31. Specifically, a connecting layer (not shown) may be formed on the second electrode 31, which may be, for example, an adhesive layer, and the flexible part 10 may be connected by the connecting layer.

### Embodiment 9

Embodiment 9 differs from Embodiment 8 in that a patterned barrier layer is further formed prior to the formation of the patterned first sacrificial layer.

Particular reference is now made to FIGS. 17 to 19, which are partial schematic cross-sectional views of structures formed in the method according to Embodiment 9 of the present invention. Reference may be made further to FIGS. 1 to 16.

Referring to FIG. 17, a schematic drawing based on FIG. 16, in embodiments hereof, the formation of the motion controller may further include, prior to the formation of the patterned first sacrificial layer 110, forming a barrier layer 120 on the substrate 100. The barrier layer 120 may be formed of silicon nitride by physical vapor deposition, chemical vapor deposition or a similar semiconductor process. Optionally, the barrier layer 120 may have a thickness between 1000 Å and 5000 Å, such as 1500 Å, 2000 Å, 3000 Å or 4000 Å.

Next, as shown in FIG. 18, the barrier layer 130 is etched and patterned so that part of the underlying substrate 100 is exposed therefrom. The patterned barrier layer 130 may include a first anti-adhesive section 131, a flat section 132 and an alignment section 133, which are sequentially located in this order in the direction away from the exposed part of the substrate 100. The first anti-adhesive section 131 is formed to avoid a movable part 41 subsequently formed thereon from adhering to a layer in which the first anti-adhesive section 131 is situated and thus allows improved quality and reliability of the movable part 41. The flat section 132 is a section on which the first 30 and second 31 electrodes are to be subsequently formed. The alignment section 133 is formed as an alignment feature for any subsequent film-formation process. In embodiments hereof, a cross-sectional width of the first anti-adhesive section 131 may account for 20%-60% of a total cross-sectional width of the patterned barrier layer 130. A cross-sectional width of the flat section 132 may account for 20%-60% of the total cross-sectional width of the patterned barrier layer 130. A cross-sectional width of the alignment section 133 may account for 5%-20% of the total cross-sectional width of the patterned barrier layer 130.

The first anti-adhesive section 131 may include a number of barrier blocks, which are spaced apart from one another and may appear rectangular when projected on a surface of the substrate 100. Each barrier block may have a cross-sectional width between 1000 Å and 5000 Å and spaced from any adjacent barrier block by a distance between 1000 Å and 5000 Å. The flat section 132 may include a continuous section, that is, a continuous portion of the patterned barrier layer 130. The alignment section 133 may include an alignment mark, which may be an opening, and have a cross-sectional width between 1000 Å and 5000 Å.

As shown in FIG. 19, in embodiments hereof, the flat section 132 may be partially exposed in each of the first 111 and second 112 openings. The first opening 111 may be located closer to the alignment section 133 than the second opening 112. Optionally, in the patterned first sacrificial layer 110, a third opening 113 extending therethrough in the thickness-wise direction may be formed. In this case, the flat section 132 may also be partially exposed in the third opening 113, and the third opening 113 may be located closer to the alignment section 133 than the first opening 111. The third opening 113 may be formed to allow the formation of a side wall 24, which may be formed simultaneously with the first 30 and second 31 electrodes.

Reference may be made to the descriptions of the last embodiment for any other details of the method that have not been described in the description of this embodiment, and any repeated description will be omitted for the sake of brevity.

### Embodiment 10

In Embodiment 10, a first voltage input terminal and a second voltage input terminal are further formed.

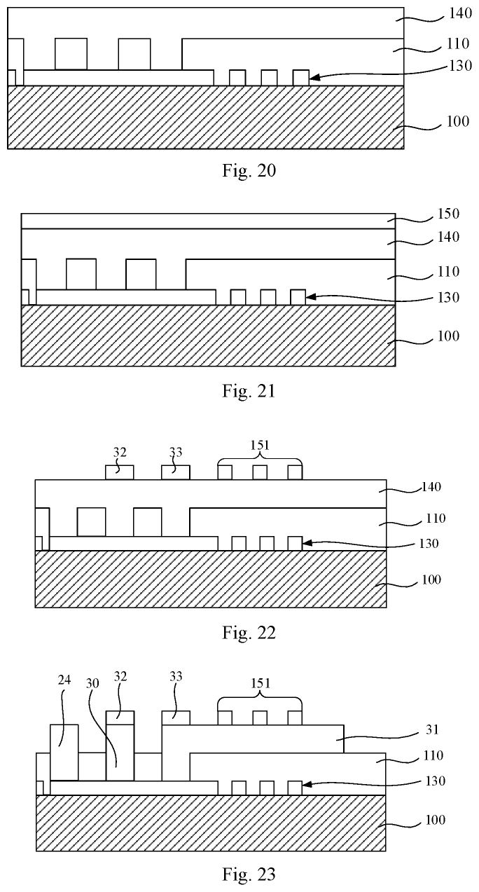

Particular reference is now made to FIGS. 20 to 24, which are partial schematic cross-sectional views of structures formed in the method according to Embodiment 10 of the present invention. Reference may be made further to FIGS. 1 to 19.

Referring to FIG. 20, a schematic drawing based on FIG. 19, in embodiments hereof, a first conductive layer 140 may be formed subsequent to the formation of the patterned first sacrificial layer 110. In the patterned first sacrificial layer 110, there may be either two openings (i.e., the first 111 and second 112 openings as shown in FIG. 13) or three openings (i.e., the first 111, second 112 and third 113 openings as shown in FIG. 19). In this embodiment, there are three openings in the patterned first sacrificial layer 110, and the first conductive layer 140 may fill all the first 111, second 112 and third 113 openings and extend across a surface of the patterned first sacrificial layer 110. Optionally, the first conductive layer 140 may be formed of doped polysilicon or silicon germanium (SiGe) and have a thickness between 1 μm and 20 μm. Optionally, the patterned first sacrificial layer 110 may be formed of silicon oxide, with the first conductive layer 140 being formed of doped polysilicon. Alternatively, the patterned first sacrificial layer 110 may be formed of germanium, with the first conductive layer 140 being formed of (doped) silicon germanium.

Subsequently, as shown in FIG. 21, a second conductive layer 150 may be formed over the first conductive layer 140. In embodiments hereof, the second conductive layer 150 may be formed of a metal such as aluminum, and may have a thickness between 0.1 μm and 10 μm.

Afterward, as shown in FIG. 22, the second conductive layer 150 may be etched to form a first voltage input terminal 32, a second voltage input terminal 33, and optionally second anti-adhesive section 151, which are spaced apart from one another. The first voltage input terminal 32 may be aligned with the first opening 111, the second voltage input terminal 33 with the second opening 112 and the second anti-adhesive section 151 with the first anti-adhesive section 131. In embodiments hereof, the second anti-adhesive section 151 may include a number of spaced conductive bumps each with a cross-sectional width between 100 nm and 5 μm and a distance of from 100 nm to 5 μm from any adjacent conductive bump.

After that, as shown in FIG. 23, the first conductive layer 140 may be etched to result in the formation of a side wall 24, the first electrode 30 and the second electrode 31, which are spaced apart from one another. The side wall 24 and the first electrode 30 may fill the third opening 113 and the first opening 111, respectively, while the second electrode 31 may fill the second opening 112 and extend over a part of the patterned first sacrificial layer 110. In other embodiments hereof, etching the first conductive layer 140 to form the spaced side wall 24, first electrode 30 and second electrode 31, and also to form a connecting member 22, which may be connected to the second electrode 31 as an extension thereof.

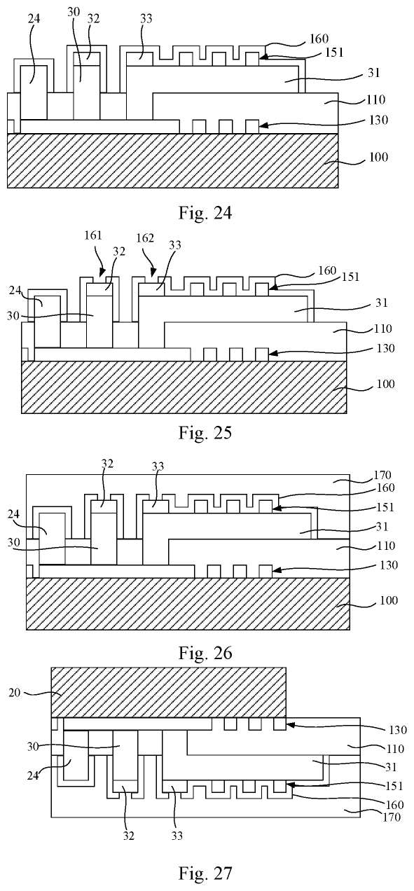

As shown in FIG. 24, in embodiments hereof, the method may further include forming a patterned insulating layer 160, which may cover the first voltage input terminal 32, the second voltage input terminal 33, the second anti-adhesive section 151, and exposed surfaces of the side wall 24, the first electrode 30 and the second electrode 31. The patterned insulating layer 160 ensures reliable electrical isolation, and prevents electrical connection, between the first 30 and second 31 electrodes. In embodiments hereof, the patterned insulating layer 160 may be a silicon nitride layer with a thickness ranging from 0.1 μm to 5 μm.

Reference may be made to the descriptions of the preceding embodiments for any other details of the method that have not been described in the description of this embodiment, and any repeated description will be omitted for the sake of brevity.

### Embodiment 11

Embodiment 11 differs from the preceding embodiments in that the flexible part is connected to the second electrode subsequent to the formation of the second electrode and prior to the suspension of the movable part of the second electrode over the mount.

Particular reference is now made to FIGS. 25 to 30, which are partial schematic cross-sectional views of structures formed in the method according to Embodiment 11 of the present invention. Reference may be made further to FIGS. 1 to 24.

Referring to FIG. 25, a schematic drawing based on FIG. 24, in embodiments hereof, the method may further include, subsequent to the formation of the patterned insulating layer 160, forming in the patterned insulating layer 160, a first slot 161 in which at least a part of the first voltage input terminal 32 is exposed and a second slot 162 in which at least a part of the second voltage input terminal 33 is exposed. In alternatively embodiments hereof, instead of separate slots, the first 161 and second 162 slots may be formed as parts of respective openings. For example, after a cap layer is subsequently formed, the cap layer may be etched together with the patterned insulating layer 160 to formed therein seventh and eighth openings in which the first 32 and second 33 voltage input terminals are exposed, respectively. In this case, the first and second slots may be parts of the seventh and eighth openings, respectively, and any repeated description of them will be omitted.

Additionally, an electroless plating process may be performed to form an electroless nickel-immersion gold coating (not shown) on exposed surfaces of the first 32 and second 33 voltage input terminals in order to protect these terminals.

Subsequently, as shown in FIG. 26, a second sacrificial layer 170 may be formed, which covers the patterned insulating layer 160 and the exposed patterned first sacrificial layer 110. In embodiments hereof, the second sacrificial layer 170 may further cover the exposed first 32 and second 33 voltage input terminals, i.e., fill the first 161 and second 162 slots. Optionally, a top surface of the second sacrificial layer 170 may be 0.5 μm-5 μm higher than a top (highest) surface of the patterned insulating layer 160. Specifically, this can be accomplished by depositing the second sacrificial layer 170 and performing thereon a chemical mechanical polishing process to make the thickness of the second sacrificial layer 170 meet requirement. Further, in order for the thickness of the second sacrificial layer 170 to be accurately controlled, multiple chemical mechanical polishing processes may be employed to process the second sacrificial layer 170 for multiple times. The second sacrificial layer 170 may function to protect the first 30 and second 31 electrodes and other components. The second sacrificial layer 170 may be made of silicon oxide, germanium (Ge) or a similar material.

As shown in FIG. 27, in embodiments hereof, the mount 20 may be formed by etching the substrate 100 from the backside thereof. Specifically, the substrate 100 may be etched from the backside thereof so that a part of the patterned first sacrificial layer 110 that is aligned with a part of the second electrode 31 is exposed.

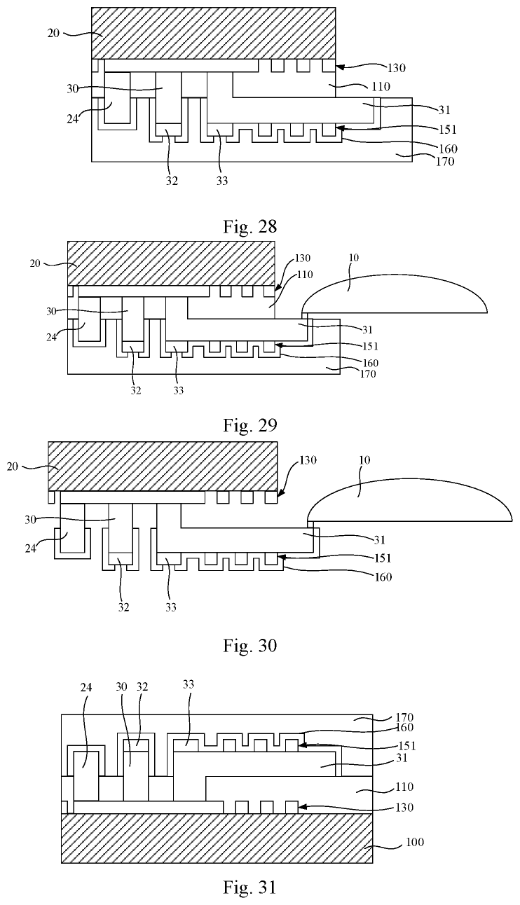

Afterward, as shown in FIG. 28, the exposed part of the patterned first sacrificial layer 110 may be removed, resulting in the exposure of said aligned part of the second electrode 31. The exposed part of the second electrode 31 may face part of the surface of the mount 20. The exposed part of the patterned first sacrificial layer 110 may be removed using a wet etching process. Specifically, this wet etching process may employ a buffered oxide etch (BOE) solution.

Next, as shown in FIG. 29, the flexible part 10 may be connected to the second electrode 31. Specifically, a connecting layer (not shown) for bonding the flexible part 10 may be formed on the second electrode 31. More specifically, the connection of the component 10 to be moved to the second electrode 31 may be accomplished by an adhesive layer dispensed on the second electrode 31 as a spot, patch or ring-like pattern. The adhesive layer may be chosen as any suitable existing adhesive material such as polyurethane, polyacrylate, etc.

As shown in FIG. 30, the second sacrificial layer 170 and the (remaining) patterned first sacrificial layer 110 may be removed so that the second electrode 31 is partially suspended and partially protrudes (projects) beyond the mount 20 and that the side wall 24, the first electrode 30 and the second electrode 31 are spaced apart. The removal of the second sacrificial layer 170 and the (remaining) patterned first sacrificial layer 110 may be accomplished by a wet etching process. Specifically, the wet etching process may employ a BOE solution.

### Embodiment 12

Embodiment 12 differs from the preceding embodiments in further including the formation of a cap.

Particular reference is now made to FIGS. 31 to 37, which are partial schematic cross-sectional views of structures formed in the method according to Embodiment 12 of the present invention. Reference may be made further to FIGS. 1 to 30.

First of all, referring to FIG. 31, a schematic drawing based on FIG. 24, the method may include, subsequent to the formation of the first 30 and second 31 electrodes and prior to the etching of the substrate 100, forming a second sacrificial layer 170, which covers the patterned insulating layer 160 and the exposed patterned first sacrificial layer 110. In embodiments hereof, a top surface of the second sacrificial layer 170 may be 0.5 μm-5 μm higher than the top (highest) surface of the patterned insulating layer 160. Specifically, this can be accomplished by depositing the second sacrificial layer 170 and performing thereon a chemical mechanical polishing process to make the thickness of the second sacrificial layer meet requirement. Further, in order for the thickness of the second sacrificial layer 170 to be accurately controlled, multiple chemical mechanical polishing processes may be employed to process the second sacrificial layer 170 for multiple times.

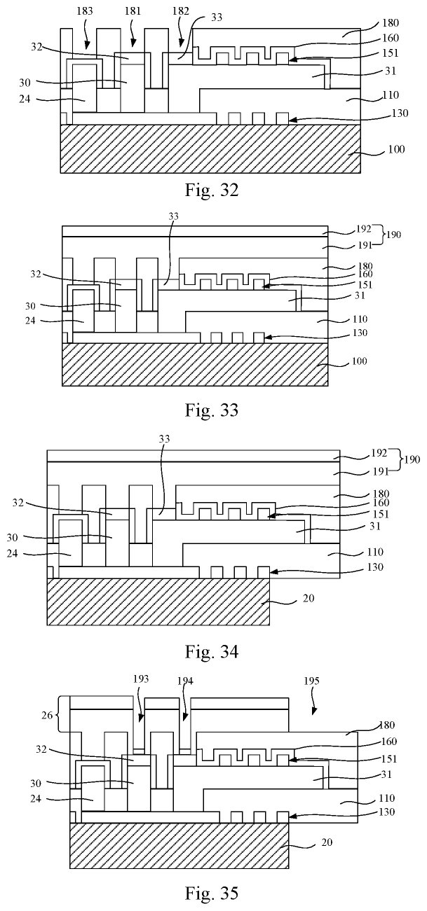

Next, as shown in FIG. 32, the second sacrificial layer 170 may be etched to form a patterned second sacrificial layer 180. The patterned second sacrificial layer 18 are provided with a fourth opening 181, a fifth opening 182 and a sixth opening 183, each extending through the patterned second layer along its thickness-wise direction. The fourth opening 181 may be aligned with the first electrode 30, the fifth opening 182 with the second electrode 31, and the sixth opening 183 with the side wall 24. Accordingly, as shown in FIG. 19, the fourth opening 181 may be aligned with the first opening 111, the fifth opening 182 with the second opening 112, and the sixth opening 183 with the third opening 113.

After that, as shown in FIG. 33, a cap layer 190 may be formed, which fills the fourth 181, fifth 182 and sixth 183 openings and extends over the exposed patterned second sacrificial layer 180. In embodiments hereof, the cap layer 190 may include a first cap layer 191 and a second cap layer 192 covering the first cap layer 191. The first cap layer 191 may fill the fourth 181, fifth 182 and sixth 183 openings and extend over the exposed patterned second sacrificial layer 180. Optionally, the first cap layer 191 may be an undoped polysilicon layer, while the second cap layer 192 may be a nitride layer.

As shown in FIG. 34, in embodiments hereof, the substrate 100 may be then etched to result in the formation of the mount 20. Specifically, the substrate 100 may be etched from the backside thereof so that a part of the patterned first sacrificial layer 110 that is aligned with a part of the second electrode 31 is exposed.

Subsequently, as shown in FIG. 35, a cap 26 may be formed by etching the cap layer 190. In the cap 26, a seventh opening 193, an eighth opening 194 and a ninth opening 195, each extending through the cap layer along its thickness-wise direction, may be formed, the seventh opening 193 being aligned with the first opening 111 and extending though the patterned insulating layer 160 so that the first voltage input terminal 32 is exposed therein, the eighth opening 194 being aligned with the second opening 112 and extending though the patterned insulating layer 160 so that the second voltage input terminal 33 is exposed therein, the ninth opening 195 being aligned with a part of the patterned first sacrificial layer 110. The part of the patterned first sacrificial layer 110 that is exposed from the etching of the substrate 100 and the part of the patterned first sacrificial layer 110 aligned with the ninth opening 195 may be the same part of the patterned first sacrificial layer.

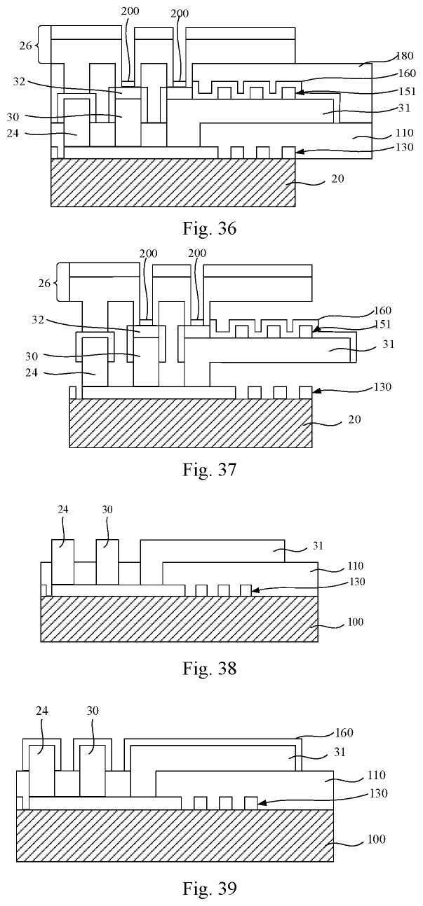

In embodiments hereof, as shown in FIG. 36, a protective layer 200 may be then formed on the first 32 and second 33 voltage input terminals. Specifically, the protective layer 200 may be formed as an electroless nickel-immersion gold coating.

After that, as shown in FIG. 37, the patterned first 110 and second 180 sacrificial layers may be removed so that the second electrode 31 is partially suspended.

Next, a connecting layer (not shown) for connecting the component 10 to be moved may be formed on the second electrode 31, for example, as an adhesive spot. Specifically, the connecting layer may be formed on a suspended end portion of the second electrode 31, e.g., the second end 43 of the second electrode 31, as shown in FIG. 2.

Reference may be made to the descriptions of the preceding embodiments for any other details of the method that have not been described in the description of this embodiment, and any repeated description will be omitted for the sake of brevity.

### Embodiment 13

Embodiment 13 differs from the preceding embodiments in that the first 32 and second 33 voltage input terminals are formed on a backside of the mount 20, i.e., the surface of the mount 20 opposite to where the first 30 and second 31 electrodes are located.

Particular reference is now made to FIGS. 38 to 47, which are partial schematic cross-sectional views of structures formed in the method according to Embodiment 13 of the present invention. Reference may be made further to FIGS. 1 to 37.

First of all, referring to FIG. 20, a first conductive layer 140 may be formed, which fills the first 111, second 112 and third 113 openings and extends over the surface of the patterned first sacrificial layer 110.

Next, as shown in FIG. 38, a schematic drawing based on FIG. 20, the first conductive layer 140 may be etched so that the spaced side wall 24, first electrode 30 and second electrode 31 are formed. In embodiments hereof, a connecting member 22 connected to the second electrode 31 may be formed at the same time. The side wall 24 may fill the third opening 113, with the first 30 and second 31 electrodes filling the first 111 and second 112 openings, respectively, and the second electrode further extending over a part of the patterned first sacrificial layer 110.

As shown in FIG. 39, the patterned insulating layer 160 may be then formed, which cover the exposed surfaces of the side wall 24, first electrode 30 and second electrode 31.

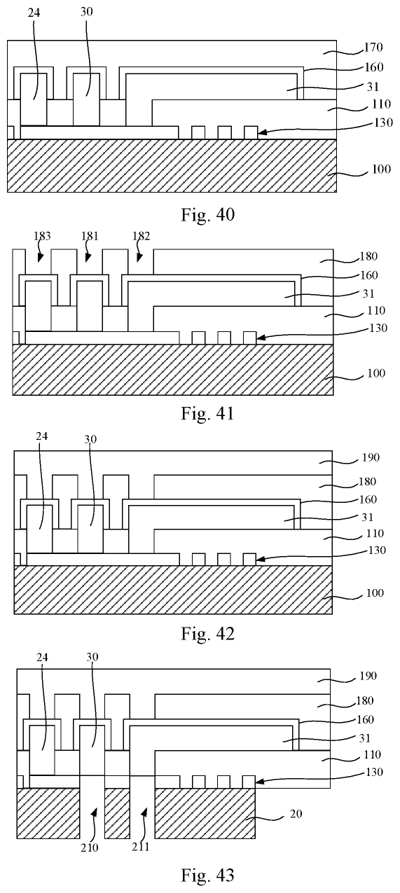

As shown in FIG. 40, the second sacrificial layer 170 may be then formed, which covers the patterned insulating layer 160 and the exposed patterned first sacrificial layer 110.

Subsequently, as shown in FIG. 41, the second sacrificial layer 170 may be etched to form a patterned second sacrificial layer. The patterned second sacrificial layer is provided with the fourth 181, fifth 182 and sixth 183 openings each extending through the second sacrificial layer along its thickness-wise direction. The fourth opening 181 may be aligned with the first electrode 30, the fifth opening 182 with the second electrode 31, and the sixth opening 183 with the side wall 24. Accordingly, as shown in FIG. 19, the fourth opening 181 may be aligned with the first opening 111, the fifth opening 182 with the second opening 112, and the sixth opening 183 with the third opening 113.

As shown in FIG. 42, the cap layer 190 may be formed, which fills the fourth 181, fifth 182 and sixth 183 openings and extends over the exposed patterned second sacrificial layer 180.

As shown in FIG. 43, in embodiments hereof, the substrate 100 may be then etched from the backside so that a part of the patterned first sacrificial layer 110 is exposed. Additionally, the backside etching may also result in the formation of the mount 20, and the exposed part of the patterned first sacrificial layer 110 may be aligned with a part of the second electrode 31. Further, an eleventh opening 210 and a twelfth opening 211 may be formed in the substrate 100, each of which may extend through the substrate in its thickness-wise direction. The eleventh opening 210 may be aligned with the first electrode 30 (that is, the first opening 111 of FIG. 19) and also extend through the flat section 132 so that the first electrode 30 is exposed therein. The twelfth opening 211 may be aligned with the second electrode 31 (that is, the second opening 112 of FIG. 19) and also extend through the flat section 132 so that the second electrode 31 is exposed therein.

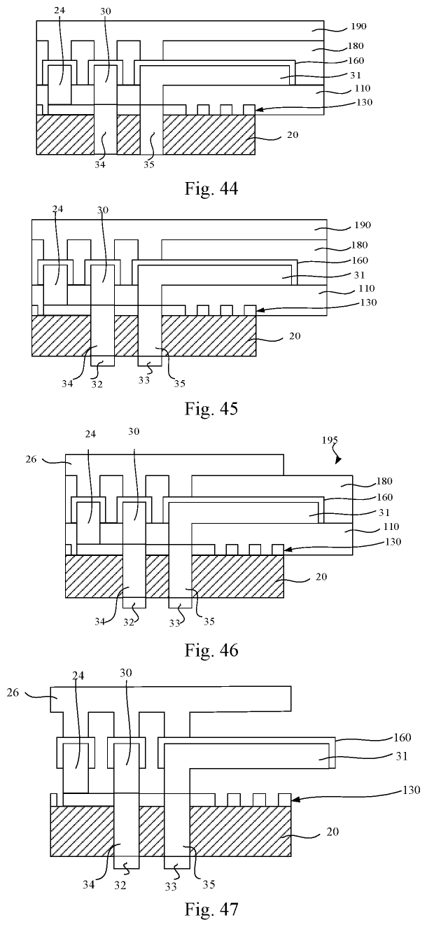

After that, as shown in FIG. 44, a first via structure 34 electrically connected to the first electrode 30 and a second via structure 35 electrically connected to the second electrode 31 may be formed in the eleventh opening 210 and the twelfth opening 211, respectively.

Afterward, as shown in FIG. 45, the first 32 and second 33 voltage input terminals may be formed in such a manner that the first voltage input terminal 32 covers and thus comes into electrical connection with the first via structure 34 and the second voltage input terminal 33 covers and thus comes into electrical connection with the second via structure 35.

Next, as shown in FIG. 46, the cap 26 may be formed by etching the cap layer 190. In the cap 26, the ninth opening 195 extending therethrough along the thickness-wise direction and aligned with a part of the patterned first sacrificial layer 110 may be formed. The part of the patterned first sacrificial layer 110 that is exposed from the etching of the substrate and the part of the patterned first sacrificial layer 110 aligned with the ninth opening 195 may be the same part of the patterned first sacrificial layer.

As shown in FIG. 47, the patterned first 110 and second 180 sacrificial layers may be removed so that the second electrode 31 is partially suspended.

After that, the connecting layer (not shown) for connecting the component 10 to be moved may be formed on the second electrode 31, for example, as an adhesive spot. Specifically, the connecting layer may be formed on a suspended end portion of the second electrode 31, e.g., the second end 43 of the second electrode 31, as shown in FIG. 2.

Reference may be made to the descriptions of the preceding embodiments for any other details of the method that have not been described in the description of this embodiment, and any repeated description will be omitted for the sake of brevity.

In summary, in the imaging module and its fabrication method provided in the present invention, the first and second electrodes are so designed that upon a voltage being applied thereto, the second electrode moves toward the first electrode, resulting in a stretch and hence a shape change of the flexible part. As a result, the focal length, amount of admitted light and/or admissible range of angle of incident light of the imaging module is/are modified. In particular, the motion controller incorporating the first and second electrodes can be easily fabricated by semiconductor processes to a very small size, making the imaging module very suitable for use in electronic terminals such as mobile phones with confined enclosure spaces.

The description presented above is merely that of some preferred embodiments of the present invention and does not limit the scope thereof in any sense. Any and all changes and modifications made by those of ordinary skill in the art based on the above teachings fall within the scope as defined in the appended claims.

1. An imaging module, comprising:
a flexible part comprising a flexible optic or a flexible diaphragm; and
a motion controller comprising a mount and at least one electrode set provided on the mount, wherein: each of the at least one electrode set comprises a first electrode and a second electrode spaced apart from the first electrode; and the second electrode comprises a fixed part and a movable part joined to the fixed part, the fixed part fixed on the mount, the movable part suspended over the mount, the movable part of the second electrode connected to the flexible part,
wherein upon a voltage being applied to the first and second electrodes, the second electrode moves toward the first electrode, resulting in a stretch and thus a shape change of the flexible part.

2. The imaging module of claim 1, wherein:
the second and first electrodes are provided with an angle equal to or less than 10 degrees; and/or
the first electrode has a length not less than 10 μm and a thickness not less than 1 μm; and/or
the second electrode has a length not less than 10 μm and not more than 500 μm, a thickness not less than 1 μm, and a width not more than 5 μm.

3. (canceled)

4. (canceled)

5. The imaging module of claim 1, wherein a plurality of electrode sets are provided on the mount and are uniformly distributed with respect to a peripheral rim of the flexible part, wherein each of the plurality of electrode sets has a connecting surface for connection to the flexible part, the connecting surface of each of the plurality of electrode sets located in a single flat plane.

6. The imaging module of claim 5, wherein;
the peripheral rim of the flexible part is connected to the connecting surfaces and has a circular cross section along the connecting surfaces; and/or
a number of the electrode sets is eight or more; and/or
a distance between any two adjacent ones of the plurality of electrode sets is 1 μm or more.

7. (canceled)

8. (canceled)

9. The imaging module of claim 1, wherein the motion controller further comprises at least one connecting member that connects the second electrode(s) in the at least one electrode set to the flexible part in such a manner that each connecting member connects at least one second electrode, or that each connecting member connects one second electrode and is aligned with the first electrode as the connected second electrode that is slanted between the connecting member and the first electrode, or that each connecting member connects two or more second electrodes, wherein the second electrodes connecting to a same connecting member is arranged in symmetry with respect to an axis of the connecting member, and
wherein the at least one connecting member is adhesively bonded to the flexible part and is integrally formed with, or adhesively bonded to, the second electrode.

10. (canceled)

11. The imaging module of claim 1, wherein the motion controller further comprises a side wall, wherein the side wall is arranged on the mount and forms a first receptacle with the mount, wherein the electrode set is accommodated in the first receptacle such that the first electrode is closer to the side wall than the second electrode and a part of the second electrode protrudes beyond the mount, and wherein the motion controller further comprises a cap disposed on the side wall, wherein the cap forms, together with the side wall and the mount, a second receptacle where the electrode set is accommodated such that a part of the second electrode protrudes beyond the mount and the cap.

12. The imaging module of claim 1, wherein:
the flexible part is formed of a gel-like material with a Young's modulus that is less than 200 MPa; or
the flexible part is formed of an organic polymer comprising polydimethylsiloxane or polyimide; or
the flexible part is a flexible optic with a focal length variable as a result of a shape change of the flexible part, wherein the flexible optic comprises a spherical, an aspheric or a profiled optic.

13. (canceled)

14. (canceled)

15. A method for fabricating an imaging module, comprising:
forming a motion controller comprising a mount and at least one electrode set provided on the mount, wherein the electrode set comprises a first electrode and a second electrode spaced apart from the first electrode; and the second electrode comprises a fixed part and a movable part joined to the fixed part, the fixed part fixed on the mount, the movable part suspended over the mount; and
connecting a flexible part to the movable part of the second electrode, wherein the flexible part comprises a flexible optic or a flexible diaphragm,
wherein upon a voltage being applied to the first and second electrodes, the second electrode moves toward the first electrode, resulting in a stretch and thus a shape change of the flexible part.

16. The method for fabricating an imaging module of claim 15, wherein the formation of the motion controller comprises:
providing a substrate;
forming a patterned first sacrificial layer on the substrate, wherein the patterned first sacrificial layer has a first opening and a second opening, each opening extending through the patterned first sacrificial layer in a thickness-wise direction thereof,
forming the first and second electrodes, wherein the first electrode fills the first opening; and the fixed part of the second electrode fills the second opening, the second electrode extending over a part of the patterned first sacrificial layer to form the movable part;
etching the substrate from a backside thereof so that a part of the patterned first sacrificial layer that is aligned with a part of the second electrode is exposed;
removing the patterned first sacrificial layer; and
forming, on the second electrode, a connecting layer for connecting the flexible part.

17. The method for fabricating an imaging module of claim 16, wherein prior to the formation of the patterned first sacrificial layer, the formation of the motion controller further comprises:
forming a barrier layer on the substrate; and
etching the barrier layer to form a patterned barrier layer, wherein the patterned barrier layer exposes a part of the substrate, and comprises a first anti-adhesive section, a flat section and an alignment section, which are sequentially arranged in a direction away from the exposed part of the substrate,
wherein a part of the flat section is exposed from each of the first and second opening, and wherein the first opening is closer to the alignment section than the second opening, and
wherein the patterned first sacrificial layer further comprises a third opening extending through the first sacrificial layer in the thickness-wise direction, and wherein the third opening exposes a part of the flat section and is closer to the alignment section than the first opening.

18. (canceled)

19. The method for fabricating an imaging module of claim 17 wherein the formation of the first and second electrodes comprises:
forming a first conductive layer, wherein the first conductive layer fills the first, second and third openings and extends across a surface of the patterned first sacrificial layer;
forming a second conductive layer covering the first conductive layer;
forming a first voltage input terminal, a second voltage input terminal and a second anti-adhesive section, which are spaced apart from one another, by etching the second conductive layer, wherein: the first voltage input terminal is aligned with the first opening; the second voltage input terminal is aligned with the second opening; and the second anti-adhesive section is aligned with the first anti-adhesive section;
forming a side wall and the first and second electrodes, which are spaced apart from one another, by etching the first conductive layer, wherein: the side wall fills the third opening; the first electrode fills the first opening; and the second electrode fills the second opening and extends over a part of the patterned first sacrificial layer; and
forming a patterned insulating layer, wherein the patterned insulating layer covers the first voltage input terminal, the second voltage input terminal, the second anti-adhesive section and exposed surfaces of the side wall, the first electrode and the second electrode.

20. The method for fabricating an imaging module of claim 19, wherein subsequent to the formation of the patterned insulating layer and prior to exposure of the part of the patterned first sacrificial layer as a result of etching the substrate from the backside of the substrate, the formation of the motion controller further comprising:
forming, in the patterned insulating layer, a first slot and a second slot, wherein: the first slot exposes at least part of the first voltage input terminal; and the second slot exposes at least part of the second voltage input terminal; and
forming a second sacrificial layer, wherein the second sacrificial layer fills the first and second slots, and covers the patterned insulating layer and the exposed part of the patterned first sacrificial layer.

21. The method for fabricating an imaging module of claim 20, wherein subsequent to the exposure of the part of the patterned first sacrificial layer as a result of etching the substrate from the backside thereof and prior to the removal of the patterned first sacrificial layer, the formation of the motion controller further comprises:
removing the exposed part of the patterned first sacrificial layer; and
connecting the flexible part to the movable part of the second electrode subsequent to the removal of the exposed part of the patterned first sacrificial layer and prior to the removal of a rest of the patterned first sacrificial layer.

22. The method for fabricating an imaging module of claim 19, wherein subsequent to the formation of the first and second electrodes and prior to the etching of the substrate, the method further comprises:
forming a second sacrificial layer, wherein the second sacrificial layer covers the patterned insulating layer and the exposed part of the patterned first sacrificial layer;
etching the second sacrificial layer to form a patterned second sacrificial layer, wherein the patterned second sacrificial layer comprises a fourth opening, a fifth opening and a sixth opening, each extending through the second sacrificial layer in the thickness-wise direction, wherein: the fourth opening is aligned with the first opening; the fifth opening is aligned with the second opening; and the sixth opening is aligned with the third opening; and
forming a cap layer, wherein the cap layer fills the fourth, fifth and sixth openings and covers an exposed part of the patterned second sacrificial layer.

23. The method for fabricating an imaging module of claim 22, wherein the cap layer comprises a first cap layer and a second cap layer covering the first cap layer, and wherein the first cap layer fills the fourth, fifth and sixth openings, and covers the exposed part of the patterned second sacrificial layer, and
wherein the formation of the protective layer on the first and second voltage input terminals comprises: forming a nickel/immersion gold layer using an electroless plating process as the protective layer.

24. The method for fabricating an imaging module of claim 22, wherein subsequent to the etching of the substrate and prior to the removal of the patterned first sacrificial layer, the method further comprises:
forming a cap by etching the cap layer, wherein the cap comprises a seventh opening, an eighth opening and a ninth opening, each extending through the cap layer in the thickness-wise direction, wherein: the seventh opening is aligned with the first opening and extends through the patterned insulating layer so that the first voltage input terminal is exposed therein; the eighth opening is aligned with the second opening and extends through the patterned insulating layer so that the second voltage input terminal is exposed therein; and the ninth opening is aligned with a part of the patterned first sacrificial layer, and wherein the part of the patterned first sacrificial layer that is exposed as a result of the etching of the substrate and the part of the patterned first sacrificial layer aligned with the ninth opening are a same part of the patterned first sacrificial layer; and
forming a protective layer on the first and second voltage input terminals.

25. (canceled)

26. (canceled)

27. The method for fabricating an imaging module of claim 17 wherein the formation of the first and second electrodes comprises:
forming a first conductive layer, wherein the first conductive layer fills the first, second and third openings, and extends across a surface of the patterned first sacrificial layer;
forming a side wall and the first and second electrodes, which are spaced apart from one another, by etching the first conductive layer, wherein: the side wall fills the third opening; the first electrode fills the first opening; and the second electrode fills the second opening and extends over a part of the patterned first sacrificial layer; and
forming a patterned insulating layer, wherein the patterned insulating layer covers exposed surfaces of the side wall, the first electrode and the second electrode.

28. The method for fabricating an imaging module of claim 17, wherein subsequent to the formation of the first and second electrodes and prior to the etching of the substrate, the method further comprises:
forming a second sacrificial layer, wherein the second sacrificial layer covers the patterned insulating layer and an exposed part of the patterned first sacrificial layer;
etching the second sacrificial layer to form a second sacrificial layer, wherein the patterned second sacrificial layer comprises a fourth opening, a fifth opening and a sixth opening, each extending through the second sacrificial layer in the thickness-wise direction, wherein: the fourth opening is aligned with the first electrode; the fifth opening is aligned with the second electrode; and the sixth opening is aligned with the side wall; and
forming a cap layer, wherein the cap layer fills the fourth, fifth and sixth openings, and covers an exposed part of the patterned second sacrificial layer.

29. The method for fabricating an imaging module of claim 28, wherein during etching the substrate from the backside thereof so that the part of the patterned first sacrificial layer that is aligned with the part of the second electrode is exposed, an eleventh opening and a twelfth opening are formed in the substrate, each of which extends through the substrate in the thickness-wise direction, wherein: the eleventh opening is aligned with the first electrode and further extends through the flat section so that the first electrode is exposed therein; and the twelfth opening is aligned with the second electrode and further extends through the flat section so that the second electrode is exposed therein, and
wherein subsequent to the etching of the substrate and prior to the removal of the patterned first sacrificial layer, the method further comprises:
forming a first via structure and second via structure in the eleventh opening and the twelfth opening, respectively, wherein: the first via structure is electrically connected to the first electrode; and the second via structure is electrically connected to the second electrode; and
forming a first voltage input terminal and a second voltage input terminal in the eleventh opening and twelfth opening, respectively, wherein: the first voltage input terminal covers, and thus coming into electrical connection with, the first via structure; and the second voltage input terminal covers, and thus coming into electrical connection with, the second via structure.

30. (canceled)

31. The method for fabricating an imaging module of claim 29 wherein subsequent to the formation of the first and second voltage input terminals and prior to the removal of the patterned first sacrificial layer, the method further comprises
forming a cap by etching the cap layer, wherein the cap comprises a tenth opening extending through the cap layer in the thickness-wise direction, wherein the tenth opening is aligned with a part of the patterned first sacrificial layer, and wherein the part of the patterned first sacrificial layer that is exposed as a result of the etching of the substrate and the part of the patterned first sacrificial layer aligned with the tenth opening are a same part of the patterned first sacrificial layer.
